(19) United States
(12) Patent Application Publication
(10) Pub. No.: US 2007/0260588 A1
(43) Pub. Date: Nov. 8, 2007

(54) Selective, contextual review for documents

(75) Inventors: Ana Biazetti, Cary, NC (US); Virginia D. Hill, Raleigh, NC (US); Mary Sturgeon, Carrboro, NC (US)

Correspondence Address: HAMILTON & TERRILE, LLP, P.O. BOX 203518, AUSTIN, TX, 78720, US

(73) Assignee: International Business Machines Corporation, Armonk, NY (US)

(21) Appl. No.: 11/430,709

(22) Filed: May 8, 2006

(51) Int. Cl. G06F 17/30

(52) U.S. Cl. 707/3

(57) ABSTRACT

A method, apparatus and computer-usable medium for the selective, contextual retrieval and presentation of information used in review processes. Search criteria is entered for information to be retrieved for review and information source documents are then searched, maintaining references to the contextual levels encountered (e.g., chapter, section, sub-section, etc.). Once the search is completed, a hierarchical list of sentence extracts matching the search criteria and indicating their location in their respective source document is presented to the reviewer. The user can then select any level of the hierarchical view, which then displays an expanded view of the related section of the source document. The retrieved information can be exported to a plurality of formats, which are annotatable by the reviewer. Users are thereby provided with information relevant to the subject under review, structured and presented in the context of its usage within its associated source document.

### BACKGROUND OF THE INVENTION

1. Field of the Invention

The present invention relates in general to the field of computers and similar technologies, and in particular to software utilized in this field. Still more particularly, the invention relates to selective, contextual retrieval and presentation of information to facilitate document review.

2. Description of the Related Art

Review processes are an ongoing challenge for Information Technology (IT) departments. While the advent of the Internet and other technologies has facilitated managing the sheer amount and increasing complexity of information, there remains a need for more focused, yet flexible, review methods and tools. In particular, it would be desirable for reviewers to be able to access information relevant to their needs and areas of responsibility while maintaining a sense of contextual relevance of the information and where the information resides in the source document.

For example, software development environments are frequently matrix-managed and multidisciplinary, with teams or individuals assigned to specific functions (e.g., customer support, performance test, system test, globalization, etc.) across all projects being developed. When these teams or individuals review software specifications and design documents, they prefer to review the information that is relevant to their discipline or area, yet at the same time understand a context of that information within the document to avoid working in a vacuum. For example, the phrase “support Tier 1 Globalization” may lack relevant meaning if a reviewer did not know whether the phrase relates to “In-Plan Requirements” or “Out-Of-Plan Requirements”.

Known document processing tools provide search capabilities that can display multiple matches. These tools simply redirect a user to specific text, making it difficult to understand the context. Other specialized review tools not only fail to provide context, but may be difficult to use and may lack the flexibility to annotate the original document with reviewer comments. In view of the foregoing, it is desirable to provide improved contextual mapping of information used in review processes.

### SUMMARY OF THE INVENTION

The present invention includes, but is not limited to, a method, apparatus and computer-usable medium for the selective, contextual retrieval and presentation of information used in review processes. In an embodiment of the invention, search criteria are entered for information to be retrieved for review. Information source documents are then searched, the search results are presented while maintaining references to the hierarchical contextual levels encountered (e.g., chapter, section, sub-section, etc.) as each source document is traversed.

As search criteria are matched, information regarding the location (e.g., Chapter 3, Section 3.1, Paragraph 2) of the related information is stored in a list of matches. Once the search is completed, hierarchical information indicating the search results location in their respective source document (e.g., a hierarchical list of sentence extracts matching the search criteria), is presented to the reviewer. Reviewers are thus provided with information relevant to the subject under review, structured and presented in the context of its usage within its associated source document. The reviewer can then zoom into a specific context by choosing any level of the hierarchical view, which then displays an expanded view of the related section of the source document.

The retrieved information can be exported to a plurality of formats, which can then be annotated by the reviewer and subsequently presented to the owner of the source document. Furthermore, retrieved information can span a plurality of documents, each of which can be presented in their relative context to each other. Similarly, annotated results can then be presented, in part or in whole, to the respective owners of the source documents. The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary client computer in which the present invention may be implemented;

FIG. 2 illustrates an exemplary server from which software for executing the present invention may be deployed and/or implemented for the benefit of a user of the client computer shown in FIG. 1;

FIG. 3 shows a flow chart of an information context mapper (ICM) as implemented in accordance with an embodiment of the invention;

FIGS. 4a-b shows selective, contextual retrieval and presentation of information through a plurality of graphical depictions;

FIG. 5 shows an annotated review result exported into a predetermined format;

FIGS. 6a-b show a flow-chart of steps taken to deploy software capable of executing the steps shown and described in FIG. 3;

FIGS. 7a-c show a flow-chart of steps taken to deploy in a Virtual Private Network (VPN) software that is capable of executing the steps shown and described in FIG. 3;

FIGS. 8a-b show a flow-chart showing steps taken to integrate into a computer system software that is capable of executing the steps shown and described in FIG. 3; and

FIGS. 9a-b show a flow-chart showing steps taken to execute the steps shown and described in FIG. 3 using an on-demand service provider.

### DETAILED DESCRIPTION

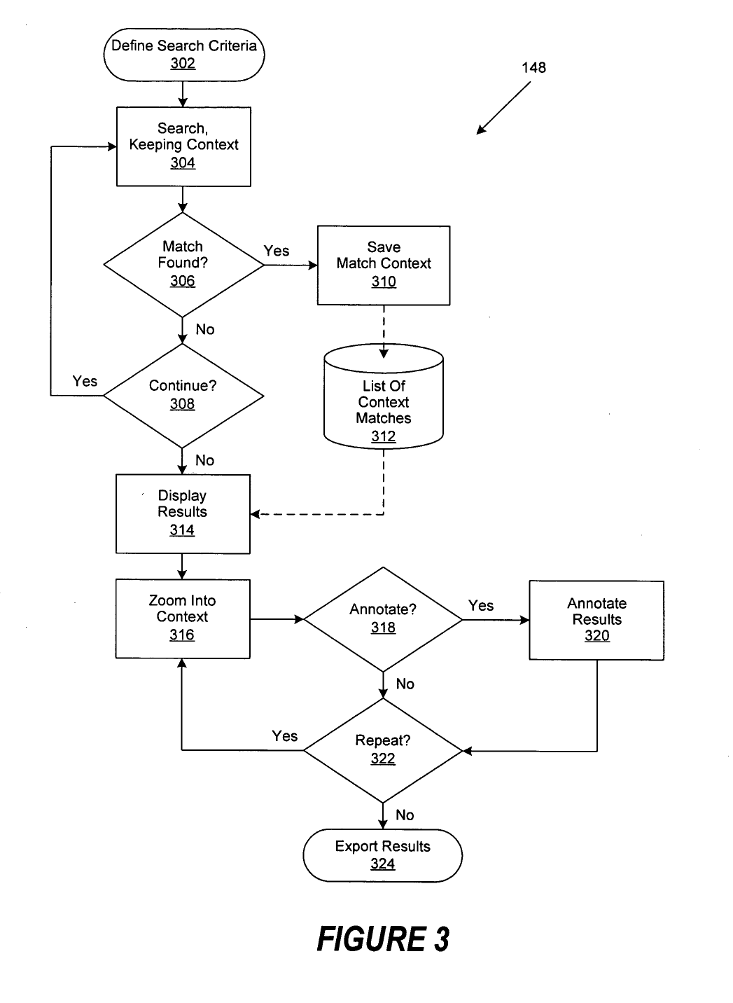

With reference now to the figures, and in particular to FIG. 3, there is depicted a method, apparatus and computer-usable medium for the selective, contextual retrieval and presentation of information used in review processes.

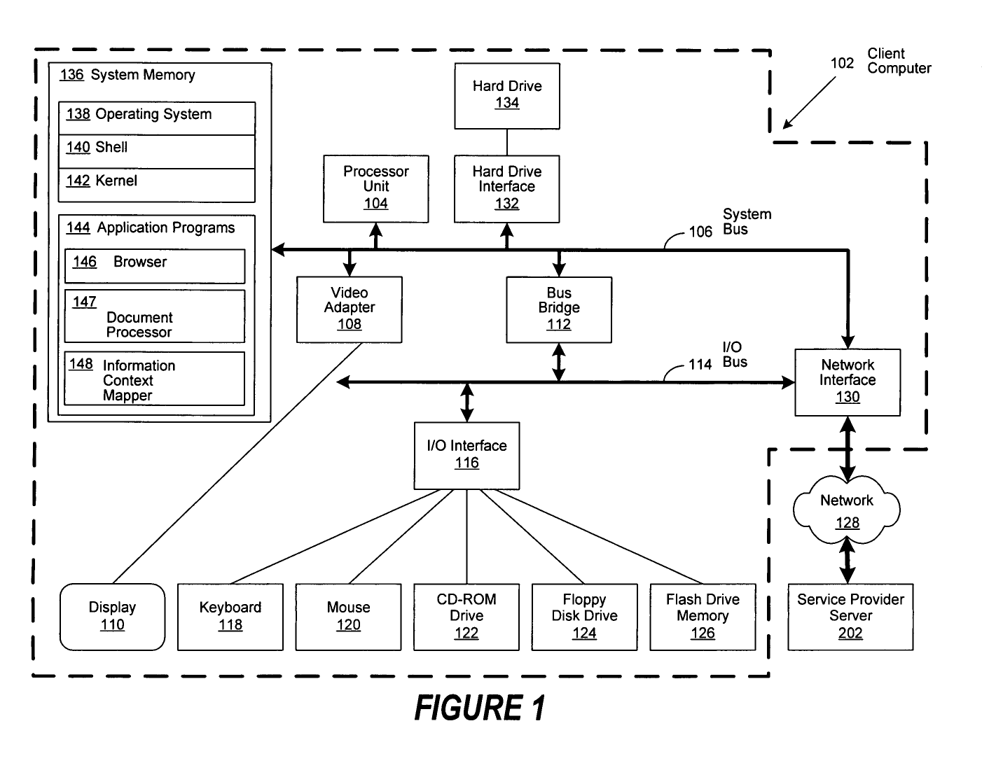

With reference now to FIG. 1, there is depicted a block diagram of an exemplary client computer 102, in which the present invention may be utilized. Client computer 102 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 416 may be any known to those skilled in the art of computer architecture, including but not limited to Universal Serial Bus (USB) ports.

Client computer 102 is able to communicate with a service provider server 202 via a network 128 using a network interface 130, which is coupled to system bus 106. Network 128 may be an external network such as the Internet, or an internal network such as an Ethernet or a Virtual Private Network (VPN). Using network 128, client computer 102 is able to access service provider server 202.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes client computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a browser 146 and a document processor 147. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 202.

Application programs 144 in client computer 102's system memory also include an information context mapper 148. Information context mapper 148 includes code for implementing the processes described in FIG. 3. In one embodiment, client computer 102 is able to download Information context mapper 148 from service provider server 202.

The hardware elements depicted in client computer 102 are not intended to be exhaustive, but rather are representative to highlight essential components required by the present invention. For instance, client computer 102 may include alternate memory storage devices such as magnetic cassettes, Digital Versatile Disks (DVDs), Bernoulli cartridges, and the like. These and other variations are intended to be within the spirit and scope of the present invention.

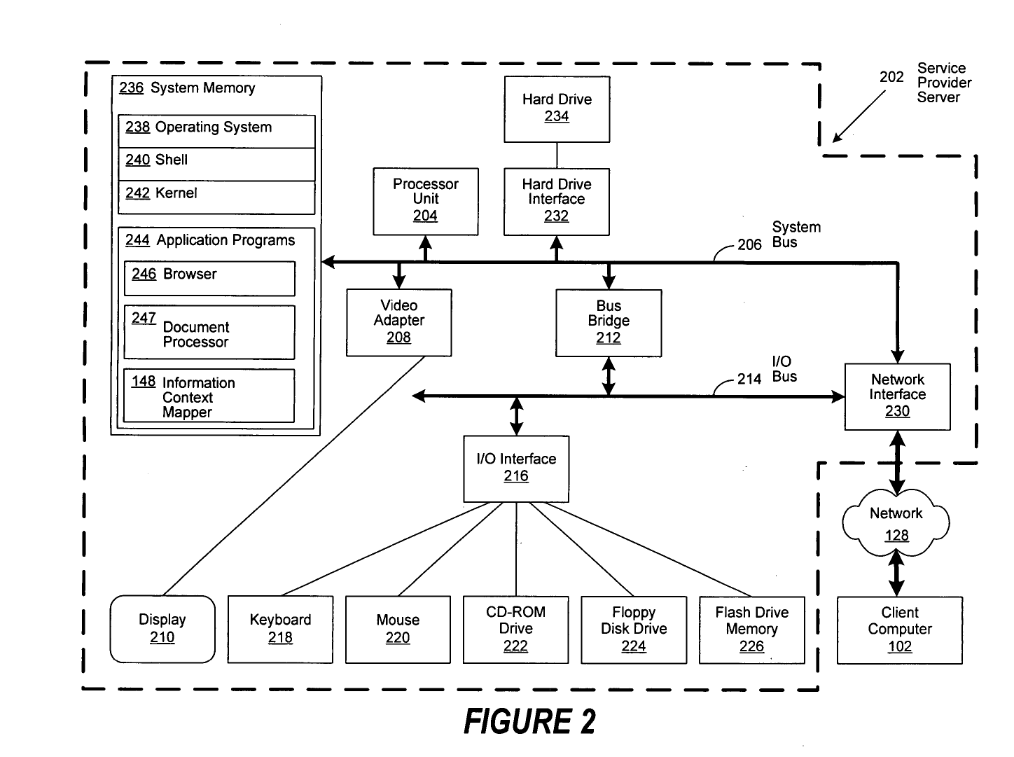

As noted above, information context mapper 148 can be downloaded to client computer 202 from service provider server 202, shown in exemplary form in FIG. 2. Service provider server 202 includes a processor unit 204 that is coupled to a system bus 206. A video adapter 208 is also coupled to system bus 206. Video adapter 208 drives/supports a display 210. System bus 206 is coupled via a bus bridge 212 to an Input/Output (I/O) bus 214. An I/O interface 216 is coupled to I/O bus 214. I/O interface 216 affords communication with various I/O devices, including a keyboard 218, a mouse 220, a Compact Disk-Read Only Memory (CD-ROM) drive 222, a floppy disk drive 224, and a flash drive memory 226. The format of the ports connected to I/O interface 216 may be any known to those skilled in the art of computer architecture, including but not limited to Universal Serial Bus (USB) ports.

Service provider server 202 is able to communicate with client computer 102 via network 128 using a network interface 230, which is coupled to system bus 206. Access to network 128 allows service provider server 202 to execute and/or download information context mapper 148 to client computer 102.

System bus 206 is also coupled to a hard drive interface 232, which interfaces with a hard drive 234. In a preferred embodiment, hard drive 234 populates a system memory 236, which is also coupled to system bus 206. Data that populates system memory 236 includes service provider server 202's operating system 238, which includes a shell 240 and a kernel 242. Shell 240 is incorporated in a higher level operating system layer and utilized for providing transparent user access to resources such as application programs 244, which include a browser 246, a document processor 247, and a copy of information context mapper 148 described above, which can be deployed to client computer 102.

The hardware elements depicted in service provider server 202 are not intended to be exhaustive, but rather are representative to highlight essential components required by the present invention. For instance, service provider server 202 may include alternate memory storage devices such as flash drives, magnetic cassettes, Digital Versatile Disks (DVDs), Bernoulli cartridges, and the like. These and other variations are intended to be within the spirit and scope of the present invention.

Note further that, in a preferred embodiment of the present invention, service provider server 202 performs all of the functions associated with the present invention (including execution of information context mapper 148), thus freeing client computer 102 from using its resources.

It should be understood that at least some aspects of the present invention may alternatively be implemented in a computer-useable medium that contains a program product. Programs defining functions on the present invention can be delivered to a data storage system or a computer system via a variety of signal-bearing media, which include, without limitation, non-writable storage media (e.g., CD-ROM), writable storage media (e.g., hard disk drive, read/write CD ROM, optical media), system memory such as but not limited to Random Access Memory (RAM), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

FIG. 3 shows a flow chart of the operation of the information context mapper 148 for selective, contextual retrieval and presentation of information used in review processes. More specifically, in Step 302, a user defines search criteria for information to be retrieved for review. In Step 304, a search for the specified information is conducted by traversing, for example, one or more predetermined source documents or information source.

If, in Step 306, a match is found while traversing a source document or information source, the hierarchical contextual level (e.g., Chapter 3, Section 3.1, Paragraph 2) is noted in Step 310, and then recorded in a list of context matches in Step 312. The search and information context mapping continues in Step 308 until no more matches to the search criteria are found. When the search and associated information content mapping has been completed, a list of results matching the search criteria is retrieved from the list of content matches from Step 312 and displayed in Step 314. The results list is, for example, in the form of sentence extracts, displayed in hierarchical form, indicating where each sentence resides in the source document. The search, and information context mapping information associated, can be presented and displayed in a variety of ways.

In Step 316, the reviewer can select a contextual match on the results list to be taken to the corresponding context level of the associated source document and have greater detail displayed, thus allowing a reviewer to zoom into a context. In Step 318, the reviewer can choose to annotate the information associated with the chosen context match or to repeat the review process with another context match. If the reviewer chooses to annotate the chosen context match, the context match is annotated in Step 320, and the reviewer can then decide in Step 322 whether to repeat the review process of another context match. If the reviewer decides to repeat the review process in Step 322, then another context match is chosen in Step 316. Otherwise, the review and annotation results are exported in predetermined formats in Step 324. If the reviewer chooses not to annotate the chosen context match, the reviewer can then decide in Step 322 whether to repeat the review process of another context match. If the reviewer decides to repeat the review process in Step 322, then another context match is chosen in Step 316. Otherwise, the review and annotation results are exported in one or more predetermined formats in Step 324.

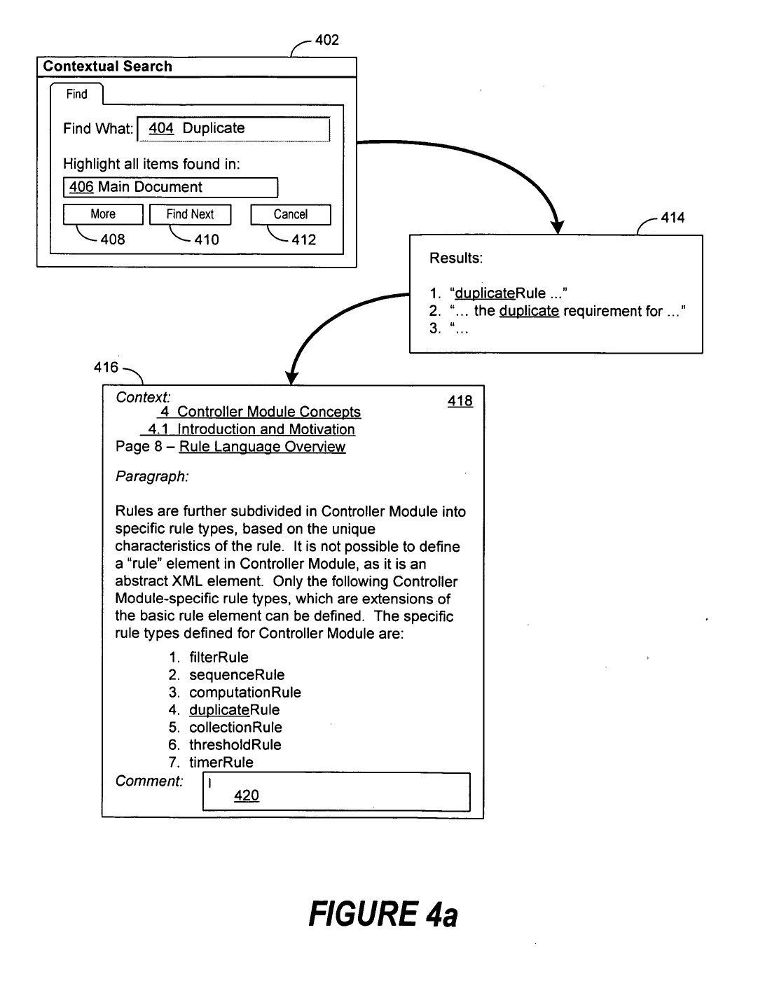

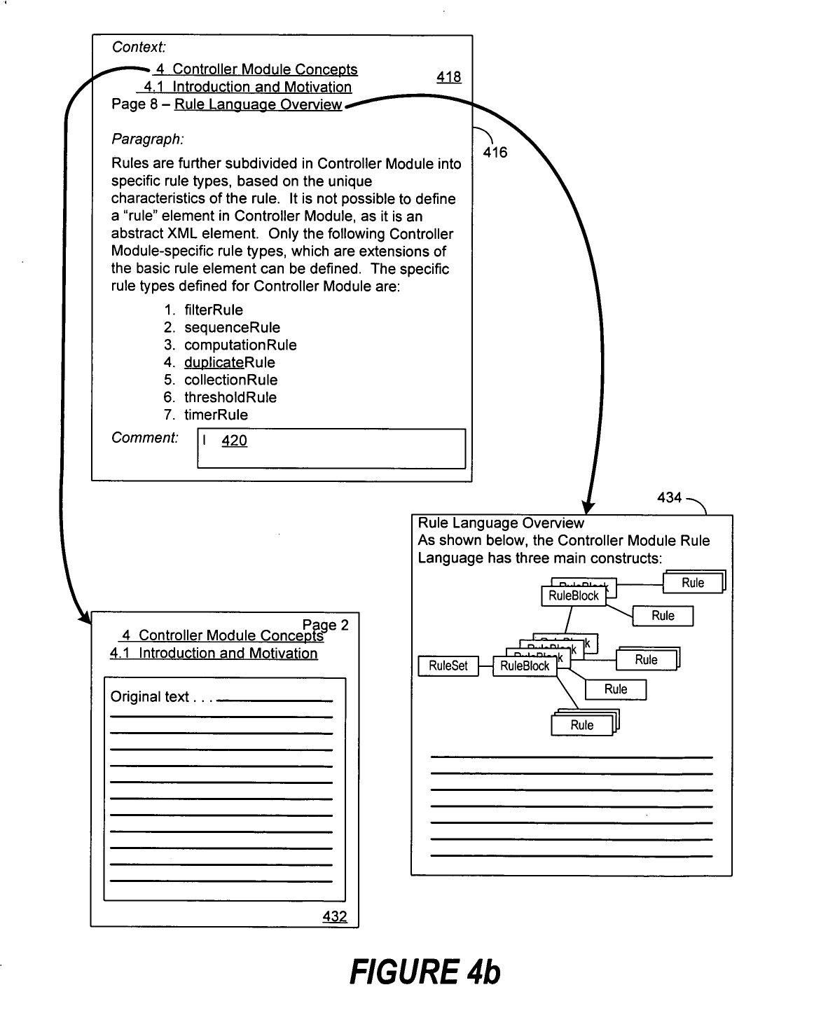

FIGS. 4a-b show selective, contextual retrieval and presentation of information through a plurality of graphical depictions via the information context mapper 148. Graphical user interface (GUI) 402 comprises entry fields for contextual information search term 404 and criteria bounding the search 406, as well as user controls for More 408, Find Next 410, and Cancel 412.

For example, the contextual information search term Duplicate may be entered in entry field 404 and Main Document may be entered in entry field 406 as the criteria bounding the search. By actuating enter, a search for the specified information is conducted by traversing one or more predetermined source documents or information source as bounded by criteria entered in entry field 406. As search term matches are found while traversing the specified source document or information source, the hierarchical contextual level (e.g., Chapter 3, Section 3.1, Paragraph 2) is noted and recorded in a list of context matches, with search and information context mapping continuing until no more matches to the search criteria are found.

Once the search and associated information content mapping has been completed, a list of results of the search criteria match is presented through GUI 416. By selecting one of the results, GUI 416 is presented which comprises hierarchical format 418, displaying the hierarchical contextual level (e.g., Chapter 4, Section 4.1, Page 8, Paragraph 2) of each sentence extract as it resides in the source document, and a comment field 420, providing the ability for the user to annotate the retrieved information.

Referring now to FIG. 4b, through interactions with hierarchical format links 418, the user can then obtain an expanded contextual view of a given link in the hierarchy. Greater detail 432 can then be invoked as appropriate by the user, thus allowing them to zoom into a context. For example, by clicking on 418 “Controller Module Concepts” link, a user is presented with greater detail 432 of “session 4” of the document, or by clicking 418 “Rule Language Overview” link a user is presented with greater detail of Page 8 where the additional text is indicated by the horizontal lines within the presentation 434.

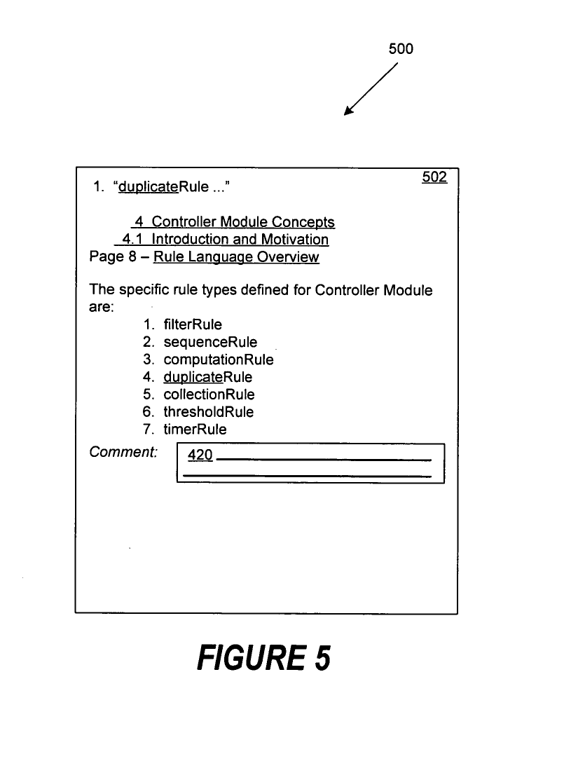

FIG. 5 shows an annotated review result 500 of the information context mapper 148. Annotated review result 500 comprises one or more contextual matches 502, each displaying a predetermined level of detail and related annotated comments 420 as appropriate.

Thus, the method described herein, and in particular as shown and described in FIG. 3 can be deployed as a process software from service provider server 202 to client computer 102.

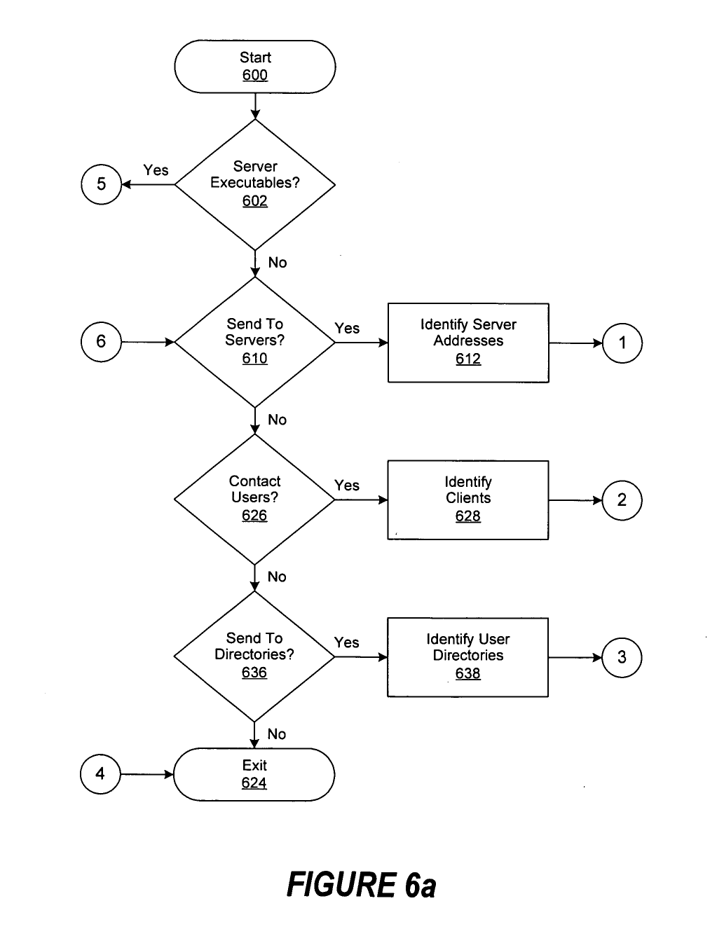

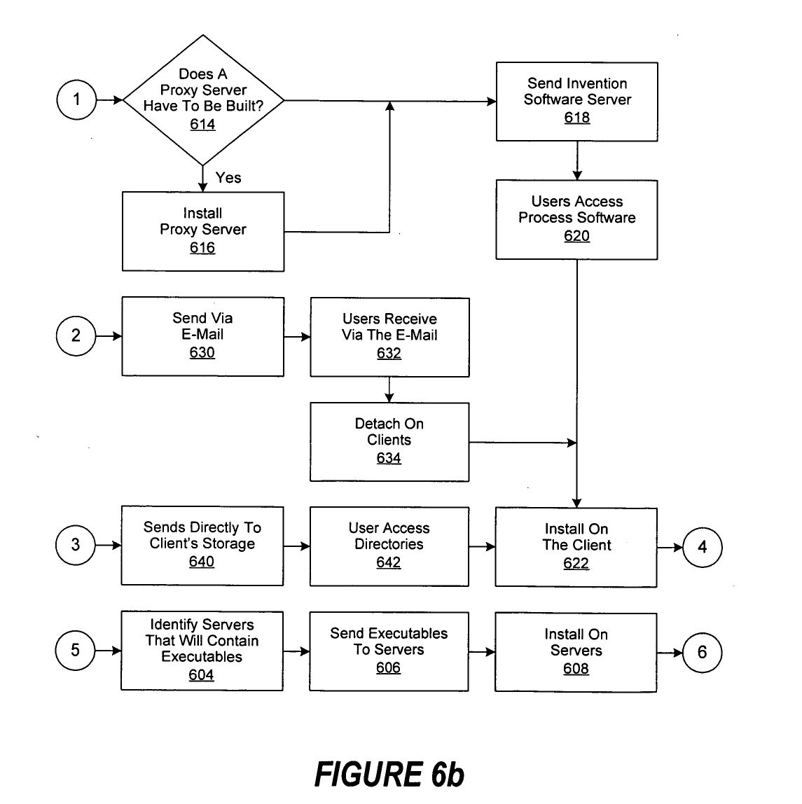

Referring then to FIG. 6, step 600 begins the deployment of the process software. The first thing is to determine if there are any programs that will reside on a server or servers when the process software is executed (query block 602). If this is the case, then the servers that will contain the executables are identified (block 604). The process software for the server or servers is transferred directly to the servers' storage via File Transfer Protocol (FTP) or some other protocol or by copying though the use of a shared file system (block 606). The process software is then installed on the servers (block 608).

Next, a determination is made on whether the process software is to be deployed by having users access the process software on a server or servers (query block 610). If the users are to access the process software on servers, then the server addresses that will store the process software are identified (block 612).

A determination is made if a proxy server is to be built (query block 614) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (block 616). The process software is sent to the servers either via a protocol such as FTP or it is copied directly from the source files to the server files via file sharing (block 618). Another embodiment would be to send a transaction to the servers that contained the process software and have the server process the transaction, then receive and copy the process software to the server's file system. Once the process software is stored at the servers, the users, via their client computers, then access the process software on the servers and copy to their client computers file systems (block 620). Another embodiment is to have the servers automatically copy the process software to each client and then run the installation program for the process software at each client computer. The user executes the program that installs the process software on his client computer (block 622) then exits the process (terminator block 624).

In query step 626, a determination is made whether the process software is to be deployed by sending the process software to users via e-mail. The set of users where the process software will be deployed are identified together with the addresses of the user client computers (block 628). The process software is sent via e-mail to each of the users' client computers (block 630). The users then receive the e-mail (block 632) and then detach the process software from the e-mail to a directory on their client computers (block 634). The user executes the program that installs the process software on his client computer (block 622) then exits the process (terminator block 624).

Lastly a determination is made on whether to the process software will be sent directly to user directories on their client computers (query block 636). If so, the user directories are identified (block 638). The process software is transferred directly to the user's client computer directory (block 640). This can be done in several ways such as, but not limited to, sharing of the file system directories and then copying from the sender's file system to the recipient user's file system or alternatively using a transfer protocol such as File Transfer Protocol (FTP). The users access the directories on their client file systems in preparation for installing the process software (block 642). The user executes the program that installs the process software on his client computer (block 622) and then exits the process (terminator block 624).

The present software can be deployed to third parties as part of a service wherein a third party VPN service is offered as a secure deployment vehicle or wherein a VPN is built on-demand as required for a specific deployment.

A virtual private network (VPN) is any combination of technologies that can be used to secure a connection through an otherwise unsecured or untrusted network. VPNs improve security and reduce operational costs. The VPN makes use of a public network, usually the Internet, to connect remote sites or users together. Instead of using a dedicated, real-world connection such as leased line, the VPN uses “virtual” connections routed through the Internet from the company's private network to the remote site or employee. Access to the software via a VPN can be provided as a service by specifically constructing the VPN for purposes of delivery or execution of the process software (i.e. the software resides elsewhere) wherein the lifetime of the VPN is limited to a given period of time or a given number of deployments based on an amount paid.

The process software may be deployed, accessed and executed through either a remote-access or a site-to-site VPN. When using the remote-access VPNs the process software is deployed, accessed and executed via the secure, encrypted connections between a company's private network and remote users through a third-party service provider. The enterprise service provider (ESP) sets a network access server (NAS) and provides the remote users with desktop client software for their computers. The telecommuters can then dial a toll-bee number or attach directly via a cable or DSL modem to reach the NAS and use their VPN client software to access the corporate network and to access, download and execute the process software.

When using the site-to-site VPN, the process software is deployed, accessed and executed through the use of dedicated equipment and large-scale encryption that are used to connect a company's multiple fixed sites over a public network such as the Internet.

The process software is transported over the VPN via tunneling which is the process of placing an entire packet within another packet and sending it over a network. The protocol of the outer packet is understood by the network and both points, called tunnel interfaces, where the packet enters and exits the network.

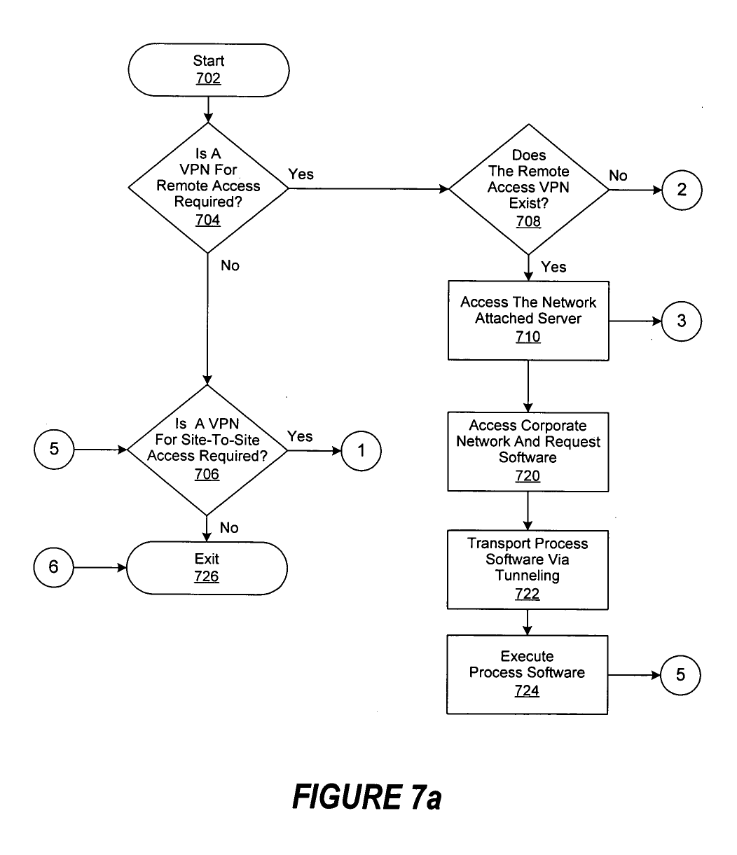

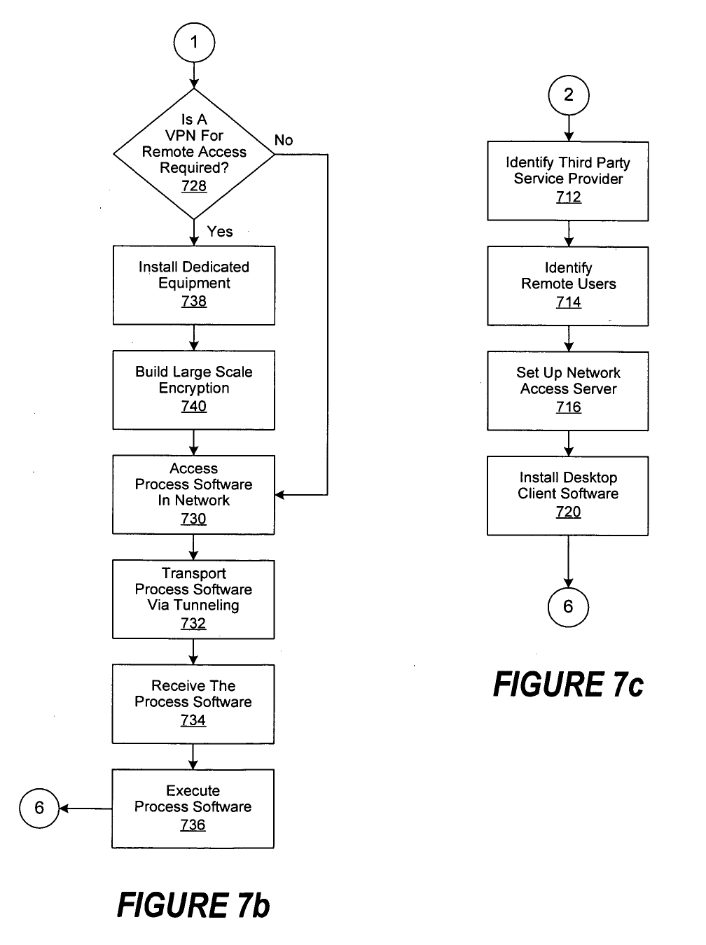

The process for such VPN deployment is described in FIG. 7. Initiator block 702 begins the Virtual Private Network (VPN) process. A determination is made to see if a VPN for remote access is required (query block 704). If it is not required, then proceed to query block 706. If it is required, then determine if the remote access VPN exists (query block 708).

If a VPN does exist, then proceed to block 710. Otherwise identify a third party provider that will provide the secure, encrypted connections between the company's private network and the company's remote users (block 712). The company's remote users are identified (block 714). The third party provider then sets up a network access server (NAS) (block 716) that allows the remote users to dial a toll free number or attach directly via a broadband modem to access, download and install the desktop client software for the remote-access VPN (block 718).

After the remote access VPN has been built or if it been previously installed, the remote users can access the process software by dialing into the NAS or attaching directly via a cable or DSL modem into the NAS (block 710). This allows entry into the corporate network where the process software is accessed (block 720). The process software is transported to the remote user's desktop over the network via tunneling. That is, the process software is divided into packets and each packet including the data and protocol is placed within another packet (block 722). When the process software arrives at the remote user's desktop, it is removed from the packets, reconstituted and then is executed on the remote user's desktop (block 724).

A determination is then made to see if a VPN for site to site access is required (query block 706). If it is not required, then proceed to exit the process (terminator block 726). Otherwise, determine if the site to site VPN exists (query block 728). If it does not exist, then proceed to block 730. Otherwise, install the dedicated equipment required to establish a site to site VPN (block 738). Then build the large scale encryption into the VPN (block 740).

After the site to site VPN has been built or if it had been previously established, the users access the process software via the VPN (block 730). The process software is transported to the site users over the network via tunneling (block 732). That is the process software is divided into packets and each packet including the data and protocol is placed within another packet (block 734). When the process software arrives at the remote user's desktop, it is removed from the packets, reconstituted and is executed on the site user's desktop (block 736). The process then ends at terminator block 726.

The process software which consists of code for implementing the process described herein may be integrated into a client, server and network environment by providing for the process software to coexist with applications, operating systems and network operating systems software and then installing the process software on the clients and servers in the environment where the process software will function.

The first step is to identify any software on the clients and servers including the network operating system where the process software will be deployed that are required by the process software or that work in conjunction with the process software. This includes the network operating system that is software that enhances a basic operating system by adding networking features.

Next, the software applications and version numbers will be identified and compared to the list of software applications and version numbers that have been tested to work with the process software. Those software applications that are missing or that do not match the correct version will be upgraded with the correct version numbers. Program instructions that pass parameters from the process software to the software applications will be checked to ensure the parameter lists matches the parameter lists required by the process software. Conversely parameters passed by the software applications to the process software will be checked to ensure the parameters match the parameters required by the process software. The client and server operating systems including the network operating systems will be identified and compared to the list of operating systems, version numbers and network software that have been tested to work with the process software. Those operating systems, version numbers and network software that do not match the list of tested operating systems and version numbers will be upgraded on the clients and servers to the required level.

After ensuring that the software, where the process software is to be deployed, is at the correct version level that has been tested to work with the process software, the integration is completed by installing the process software on the clients and servers.

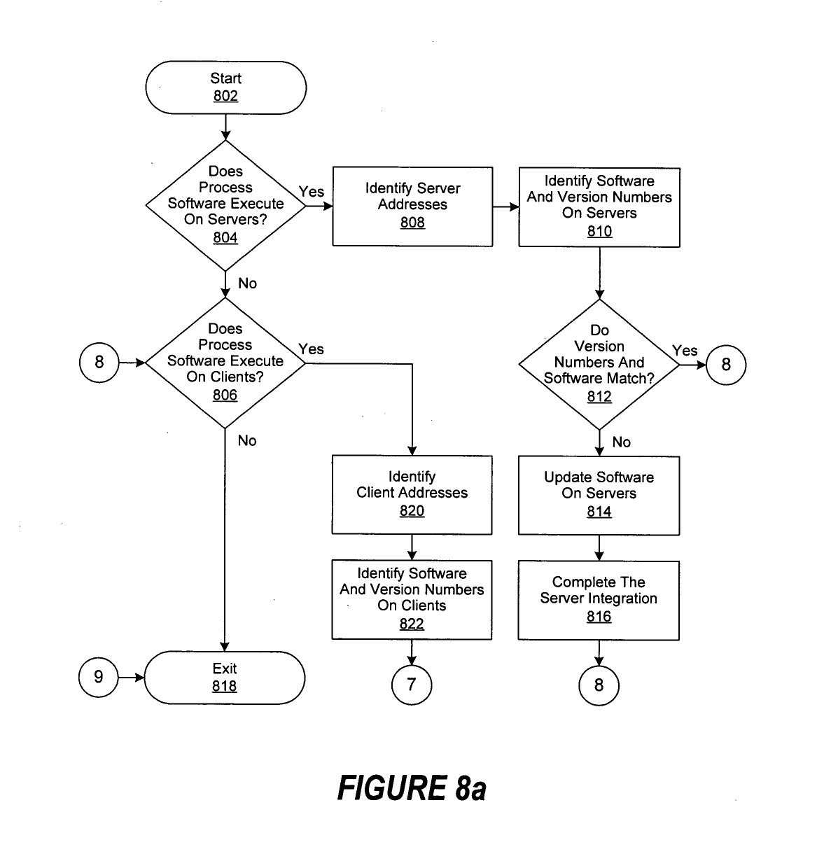

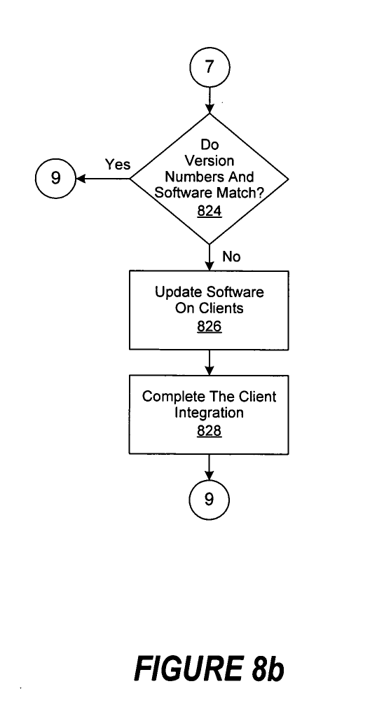

For a high-level description of this process, reference is now made to FIG. 8. Initiator block 802 begins the integration of the process software. The first tiling is to determine if there are any process software programs that will execute on a server or servers (block 8). If this is not the case, then integration proceeds to query block 806. If this is the case, then the server addresses are identified (block 808). The servers are checked to see if they contain software that includes the operating system (OS), applications, and network operating systems (NOS), together with their version numbers, which have been tested with the process software (block 810). The servers are also checked to determine if there is any missing software that is required by the process software in block 810.

A determination is made if the version numbers match the version numbers of OS, applications and NOS that have been tested with the process software (block 812). If all of the versions match and there is no missing required software the integration continues in query block 806.

If one or more of the version numbers do not match, then the unmatched versions are updated on the server or servers with the correct versions (block 814). Additionally, if there is missing required software, then it is updated on the server or servers in the step shown in block 814. The server integration is completed by installing the process software (block 816).

The step shown in query block 806, which follows either the steps shown in block 804, 812 or 816 determines if there are any programs of the process software that will execute on the clients. If no process software programs execute on the clients the integration proceeds to terminator block 818 and exits. If this not the case, then the client addresses are identified as shown in block 820.

The clients are checked to see if they contain software that includes the operating system (OS), applications, and network operating systems (NOS), together with their version numbers, which have been tested with the process software (block 822). The clients are also checked to determine if there is any missing software that is required by the process software in the step described by block 822.

A determination is made is the version numbers match the version numbers of OS, applications and NOS that have been tested with the process software (query block 824). If all of the versions match and there is no missing required software, then the integration proceeds to terminator block 818 and exits.

If one or more of the version numbers do not match, then the unmatched versions are updated on the clients with the correct versions (block 826). In addition, if there is missing required software then it is updated on the clients (also block 826). The client integration is completed by installing the process software on the clients (block 828). The integration proceeds to terminator block 818 and exits.

The process software is shared, simultaneously serving multiple customers in a flexible, automated fashion. It is standardized, requiring little customization and it is scalable, providing capacity on demand in a pay-as-you-go model.

The process software can be stored on a shared file system accessible from one or more servers. The process software is executed via transactions that contain data and server processing requests that use CPU units on the accessed server. CPU units are units of time such as minutes, seconds, hours on the central processor of the server. Additionally the assessed server may make requests of other servers that require CPU units. CPU units are an example that represents but one measurement of use. Other measurements of use include but are not limited to network bandwidth, memory usage, storage usage, packet transfers, complete transactions etc.

When multiple customers use the same process software application, their transactions are differentiated by the parameters included in the transactions that identify the unique customer and the type of service for that customer. All of the CPU units and other measurements of use that are used for the services for each customer are recorded. When the number of transactions to any one server reaches a number that begins to affect the performance of that server, other servers are accessed to increase the capacity and to share the workload. Likewise when other measurements of use such as network bandwidth, memory usage, storage usage, etc. approach a capacity so as to affect performance, additional network bandwidth, memory usage, storage etc. are added to share the workload.

The measurements of use used for each service and customer are sent to a collecting server that sums the measurements of use for each customer for each service that was processed anywhere in the network of servers that provide the shared execution of the process software. The summed measurements of use units are periodically multiplied by unit costs and the resulting total process software application service costs are alternatively sent to the customer and or indicated on a web site accessed by the customer which then remits payment to the service provider.

In another embodiment, the service provider requests payment directly from a customer account at a banking or financial institution.

In another embodiment, if the service provider is also a customer of the customer that uses the process software application, the payment owed to the service provider is reconciled to the payment owed by the service provider to minimize the transfer of payments.

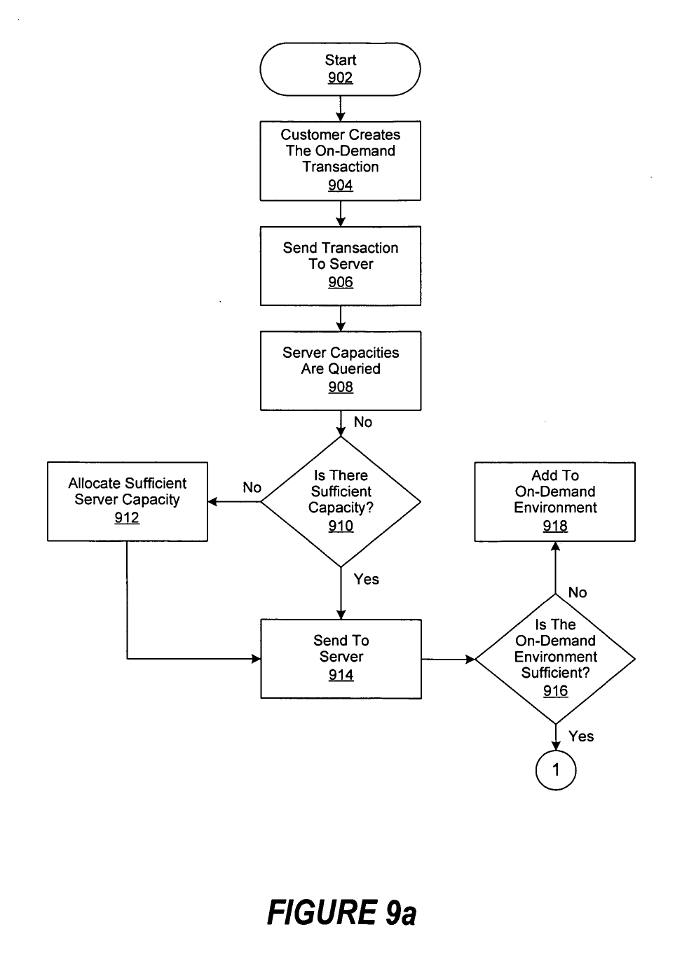

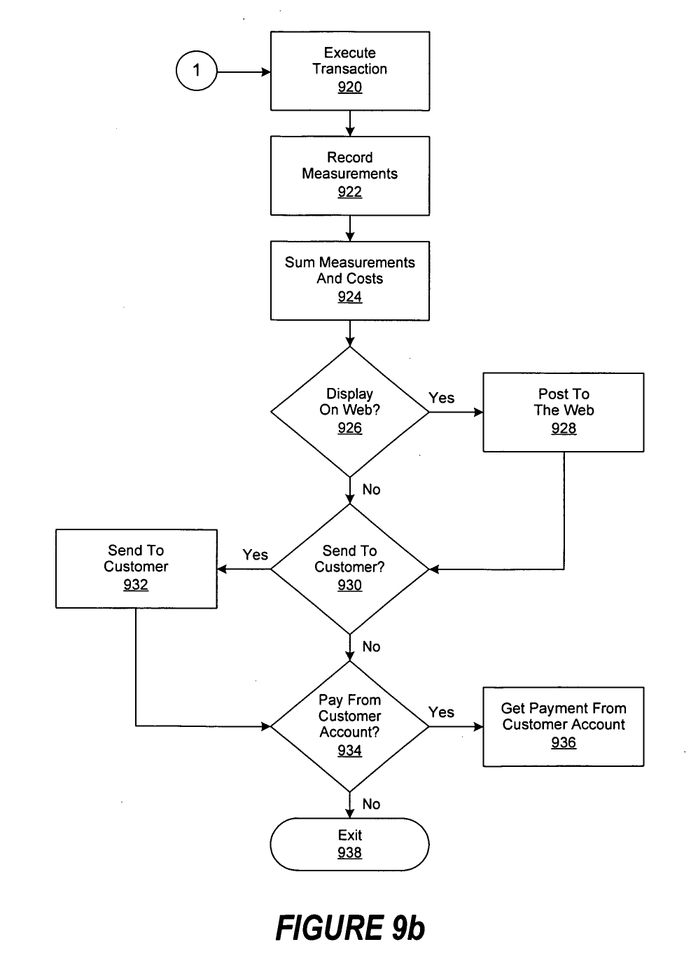

With reference now to FIG. 9, initiator block 902 begins the On Demand process. A transaction is created than contains the unique customer identification, the requested service type and any service parameters that further, specify the type of service (block 904). The transaction is then sent to the main server (block 906). In an On Demand environment the main server can initially be the only server, then as capacity is consumed other servers are added to the On Demand environment.

The server central processing unit (CPU) capacities in the On Demand environment are queried (block 908). The CPU requirement of the transaction is estimated, then the servers available CPU capacity in the On Demand environment are compared to the transaction CPU requirement to see if there is sufficient CPU available capacity in any server to process the transaction (query block 910). If there is not sufficient server CPU available capacity, then additional server CPU capacity is allocated to process the transaction (block 912). If there was already sufficient available CPU capacity then the transaction is sent to a selected server (block 914).

Before executing the transaction, a check is made of the remaining On Demand environment to determine if the environment has sufficient available capacity for processing the transaction. This environment capacity consists of such things as but not limited to network bandwidth, processor memory, storage etc. (block 916). If there is not sufficient available capacity, then capacity will be added to the On Demand environment (block 918). Next the required software to process the transaction is accessed, loaded into memory, then the transaction is executed (block 920).

The usage measurements are recorded (block 922). The usage measurements consist of the portions of those functions in the On Demand environment that is used to process the transaction. The usage of such functions as, but not limited to, network bandwidth, processor memory, storage and CPU cycles are what is recorded. The usage measurements are summed, multiplied by unit costs and then recorded as a charge to the requesting customer (block 924).

If the customer has requested that the On Demand costs be posted to a web site (query block 926), then they are posted (block 928). If the customer has requested that the On Demand costs be sent via e-mail to a customer address (query block 930), then these costs are sent to the customer (block 932). If the customer has requested that the On Demand costs be paid directly from a customer account (query block 934), then payment is received directly from the customer account (block 936). The On Demand process is then exited at terminator block 938.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implementable method for selective, contextual retrieval and presentation of information, the method comprising:
receiving search criteria;
searching at least one source document using the search criteria;
retrieving a plurality of search results corresponding to the search criteria, each of the plurality of search results comprising content information corresponding to the search criteria and hierarchical contextual information associated with the content information; and,
presenting the plurality of search results, wherein the content information and the hierarchical contextual information are presented for each of the plurality of search results.

2. The computer-implementable method of claim 1 wherein:
the hierarchical contextual information includes information relating to at least one of a chapter, a section and a sub-section for each of the search results.

3. The computer-implementable method of claim 1 further comprising:
storing the search results in a list, the list including an entry for each search result; and,
storing the hierarchical contextual information in the list where each entry in the list of search results includes a corresponding entry for the hierarchical contextual information of the search result.

4. The computer-implementable method of claim 1 wherein:
the presenting includes
organizing the content information and the hierarchical contextual information to present the hierarchical contextual information before the content information;
presenting a hierarchical list of sentence extracts for each of the search results matching the search criteria, and
indicating a location of each of the search results in a respective source document.

5. The computer-implementable method of claim 4 further comprising:
enabling a reviewer to zoom into a specific context by selecting any level of the hierarchical list of sentence extracts; and,
presenting an expanded view of a related section of the source document.

6. The computer-implementable method of claim 1 further comprising:
enabling annotation of the search results; and,
presenting the annotations along with the hierarchical list of sentence extracts.

7. A system comprising:
a processor;
a data bus coupled to the processor; and
a computer-usable medium embodying computer program code, the computer-usable medium being coupled to the data bus, the computer program code comprising instructions executable by the processor and configured for:
receiving search criteria;
searching a source document using the search criteria;
retrieving a plurality of search results corresponding to the search criteria, each of the plurality of search results comprising content information corresponding to the search criteria and hierarchical contextual information associated with the content information; and,
presenting the plurality of search results, wherein the content information and the hierarchical contextual information are presented for each of the plurality of search results.

8. The system of claim 7, wherein:
the hierarchical contextual information includes information relating to at least one of a chapter, a section and a sub-section for each of the search results.

9. The system of claim 7, wherein the instructions are further configured for:
storing the search results in a list, the list including an entry for each search result; and,
storing the hierarchical contextual information in the list where each entry in the list of search results includes a corresponding entry for the hierarchical contextual information of the search result.

10. The system of claim 7, wherein:
the instructions for presenting include instructions configured for
organizing the content information and the hierarchical contextual information to present the hierarchical contextual information before the content information;
presenting a hierarchical list of sentence extracts for each of the search results matching the search criteria, and
indicating a location of each of the search results in a respective source document.

11. The system of claim 10, wherein the instructions are further configured for:
enabling a reviewer to zoom into a specific context by selecting any level of the hierarchical list of sentence extracts; and,
presenting an expanded view of a related section of the source document.

12. The system of claim 7, wherein the instructions are further configured for:
enabling annotation of the search results; and,
presenting the annotations along with the hierarchical list of sentence extracts.

13. A computer-usable medium embodying computer program code, the computer program code comprising computer executable instructions configured for:
receiving search criteria;
searching at least one source document using the search criteria;
retrieving a plurality of search results corresponding to the search criteria, each of the plurality of search results comprising content information corresponding to the search criteria and hierarchical contextual information associated with the content information; and,
presenting the plurality of search results, wherein the content information and the hierarchical contextual information are presented for each of the plurality of search results.

14. The computer-usable medium of claim 13, wherein:
the hierarchical contextual information includes information relating to at least one of a chapter, a section and a sub-section for each of the search results.

15. The computer-usable medium of claim 13, wherein the embodied computer program code further comprises computer executable instructions configured for:
storing the search results in a list, the list including an entry for each search result; and,
storing the hierarchical contextual information in the list where each entry in the list of search results includes a corresponding entry for the information relating to contextual levels of the search result.

16. The computer-usable medium of claim 13, wherein:
the instructions for presenting include instructions configured for
organizing the content information and the hierarchical contextual information to present the hierarchical contextual information before the content information;
presenting a hierarchical list of sentence extracts for each of the search results matching the search criteria, and
indicating a location of each of the search results in a respective source document.

17. The computer-usable medium of claim 16, wherein the embodied computer program code further comprises computer executable instructions configured for:
enabling a reviewer to zoom into a specific context by selecting any level of the hierarchical list of sentence extracts; and,
presenting an expanded view of a related section of the source document.

18. The computer-usable medium of claim 13, wherein the embodied computer program code further comprises computer executable instructions configured for:
enabling annotation of the search results; and,
presenting the annotations along with the hierarchical list of sentence extracts.

19. The computer-useable medium of claim 13, wherein the computer executable instructions are deployable to a client computer from a server at a remote location.

20. The computer-useable medium of claim 13, wherein the computer executable instructions are provided by a service provider to a customer on an on-demand basis.
